(19) United States
(12) Patent Application Publication
(10) Pub. No.: US 2003/0019438 A1
(43) Pub. Date: Jan. 30, 2003

(54) Side connector assembly for a cage

(76) Inventors: Robert C. Krause, Elk Grove Village, IL (US); Yuzo Migita, Elk Grove Village, IL (US); Kazutoshi Tominaga, Elk Grove Village, IL (US)

Correspondence Address: Douglas B. White, 1000 East Woodfield Rd., #102, Schaumburg, IL, 60173, US

(21) Appl. No.: 09/915,140

(22) Filed: Jul. 25, 2001

(51) Int. Cl. A01K 1/02

(52) U.S. Cl. 119/455

(57) ABSTRACT

An expandable cage assembly has cage connecting insert assemblies. These assemblies include top and bottom terminal connecting insert members and intermediate connecting insert members. Each of the insert members have cage engaging side edges and interconnecting edges. Cage engagement channels are located on the side edges for engaging the cage, and either interconnecting tabs or tab engaging contours are located on the interconnecting edges for connecting to adjacent connecting insert members.

### CROSS REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates generally to cages for small pets, such as hamsters. More particularly, this invention relates to a cage assembly which facilitates the selection and adjustment of the height of the cage.

2. Description of the Prior Art

In the prior art, cages for small animals generally are manufactured and sold in specific sizes along with a wide variety of accessories, thus requiring the pet owner to purchase a new cage and associated apparatus whenever a larger (or smaller) cage is desired. Consequently, a need has long existed for an economical means for easily modifying the size of the cage while retaining most of the existing cage and associated apparatus.

### SUMMARY OF THE INVENTION

The objective of this invention is to provide an adjustable cage assembly which may be easily expanded (or contracted) vertically by the simple addition (or subtraction) of side connector inserts, thereby minimizing the new items needed to be purchased.

The present invention comprises an expandable cage having side connecting insert assemblies. This assembly includes a top and bottom terminal connecting insert member, each having

(a) a body portion with opposing side edges and an interconnecting edge defined thereon,

(b) cage engagement channels located on the opposing side edges for engaging the cage, and

(c) insert member interconnecting tabs or tab engaging contours for connecting to an adjacent intermediate connecting insert member.

Optionally, the terminal insert members may also include tube accessory connections for enabling the pet owner to attach tube accessories at the top and bottom of the sides.

Additionally, the assembly includes one or more intermediate connecting insert members positioned between the terminal connecting insert members, each having

(a) a body portion with upper and lower edges, and opposing side edges defined thereon,

(b) cage engagement channels located on its side edges for engaging the cage, and

(c) interconnecting tabs or tab engaging contours located on the upper and lower edges for connecting with adjacent connecting insert members.

### BRIEF DESCRIPTION OF THE DRAWINGS

FIG. 1 is a perspective view of an embodiment of an expandable cage apparatus in accordance with the present invention employing side connector insert assembly.

FIG. 2 is a side elevational view of a second embodiment of an expandable cage apparatus in accordance with the present invention.

FIG. 3 is an elevational view of a top terminal connector for use in the apparatus of FIGS. 1 and 2, shown with an optional tube accessory connection.

FIG. 4 is a bottom view of the terminal connector of FIG. 3.

FIG. 5 is an elevational view of the terminal connector of FIG. 3 shown connecting to an adjacent intermediate connector.

FIG. 6 is an elevational view of the intermediate connector shown in FIG. 5.

FIG. 7 is top view of the connector of FIG. 6.

FIG. 8 is a cross sectional view of the connector of FIG. 6.

FIG. 9 is an elevational view of the connector of FIG. 6 shown connecting with an adjacent intermediate connector.

FIG. 10 is an elevational view of a bottom terminal connector for use in the apparatus of FIGS. 1 and 2, shown with an optional tube accessory connection.

FIG. 11 is a top view of the terminal connector of FIG. 10.

FIG. 12 is an elevational view of the bottom terminal connector of FIG. 10 shown connecting to an adjacent intermediate connector.

While the invention will be described in connection with a preferred embodiment, and for convenience, reference will be made to “upper” and “lower” edges, it will be understood that it is not the intent to limit the invention to that embodiment. Clearly, it is the intent to cover all alternatives, modifications, and equivalents as may be included within the spirit and scope of the invention as defined by the appended claims.

### DESCRIPTION OF THE PREFERRED EMBODIMENT

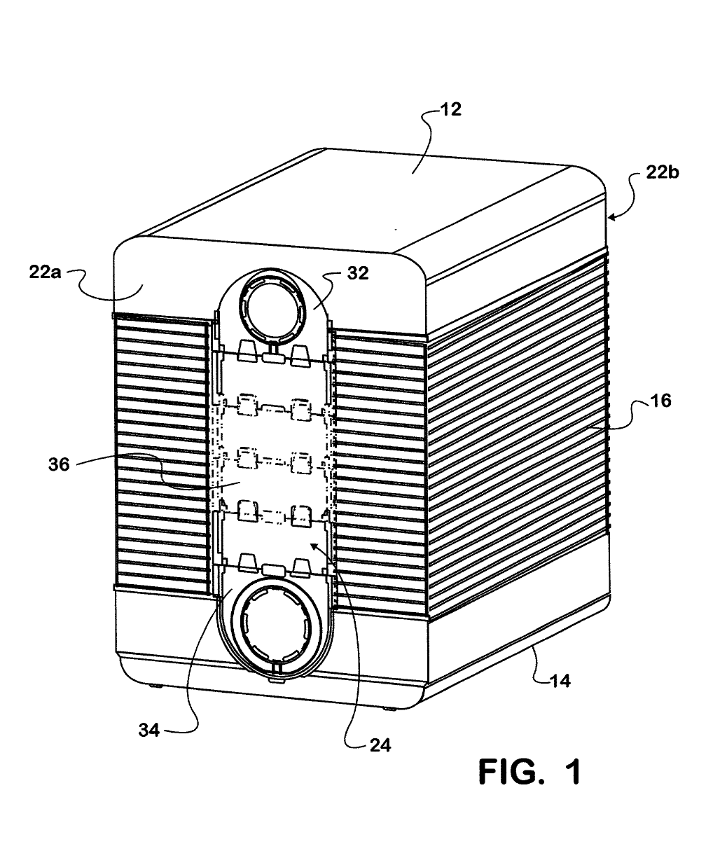

Turning first to FIG. 1 there is shown a perspective view of an expandable cage apparatus in accordance with the present invention having a top 12, a bottom 14 and sides 16 arranged to form a cage. At opposing cage ends 22a and 22b there are provided expandable side connector assemblies 24.

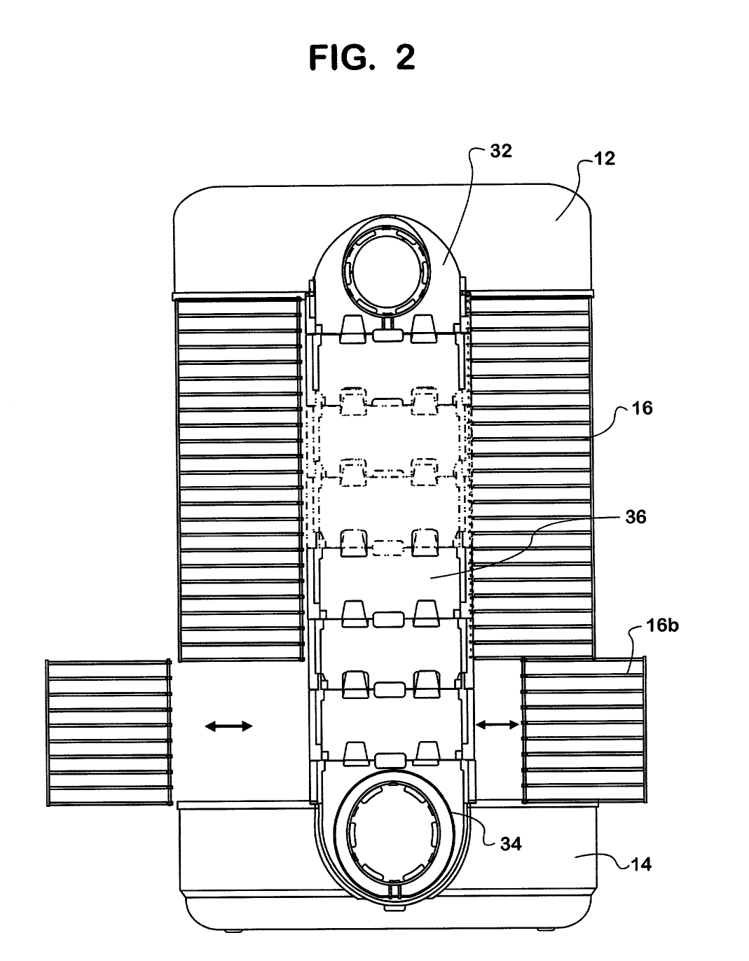

The side connector assembly 24 includes a top terminal connecting insert member 32, a bottom terminal connecting insert member 34, and intermediate connecting insert members 36. By the addition or deletion of the intermediate connecting insert members 36 the height of the cage is thereby determined; and when the cage height is changed, cage sides 16 of a different height may be used or, as shown in FIG. 2, incremental cage side inserts 16b may be added or deleted. (Clearly, a variety of cage sides and cage side inserts may be combined to form the desired cage height.)

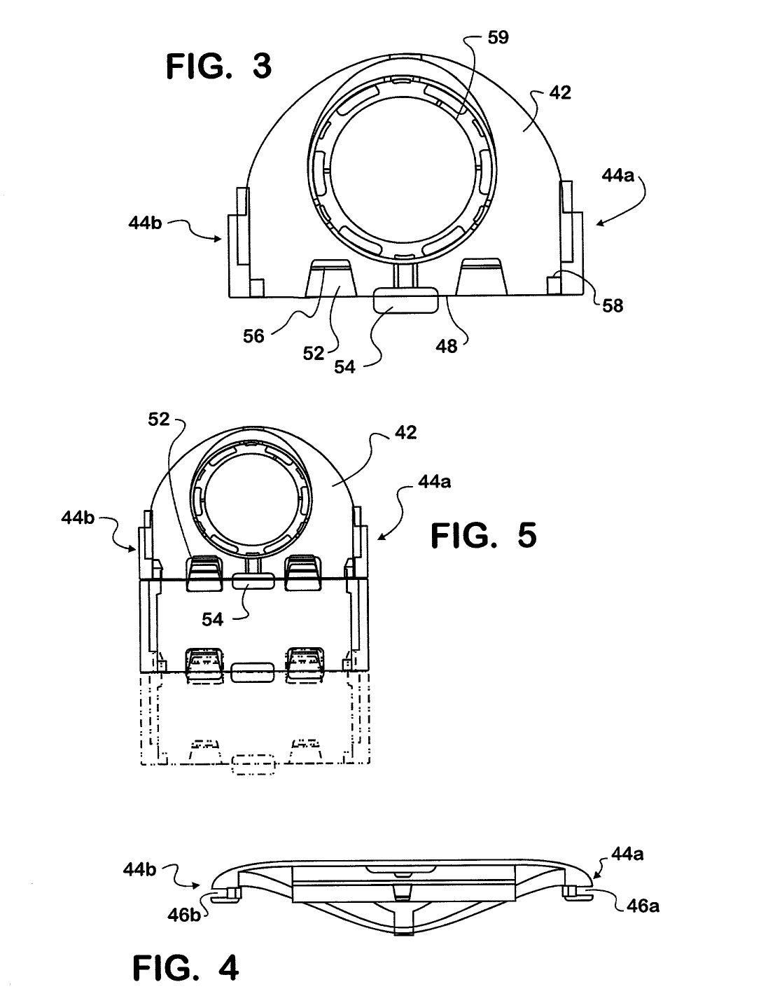

The top terminal connecting insert member 32 is depicted in detail in FIGS. 3-5. Particularly, this terminal member has a substantially planar body 42 with opposing side edges 44a and 44b. These opposing side edges present cage engagement means, such as channels 46a and 46b (see FIG. 4), for engaging the cage sides 16.

An interconnecting edge 48 is defined on the body portion 42 and presents insert member interconnecting means for securing the top terminal connecting insert member to an adjacent intermediate member. Preferably, this interconnecting means comprises an engaging tab device wherein a projecting tab from one insert member engages a tab engaging contour on an adjacent connecting insert member. For this top terminal connecting insert member, tab engaging contours 52 are provided for interconnecting to an adjacent intermediate connecting insert member, as shown in FIG. 5. The tab engaging contour 52 presents a latching edge 56 for engaging a corresponding latching edge on a protruding tab from the adjacent intermediate insert member, as described below. (Alternatively, the tab engaging contours may be replaced with engaging tabs and the adjacent engaging insert member may present the tab engaging contours.)

To further assist in securing the interconnection of the engaging tab device, there is also provided a protruding guiding tab 54. This guiding tab serves to catch against the surface of the adjacent connecting insert member and assist the engagement of the engaging tabs and corresponding tab engaging contours.

To provide additional engagement between the insert members the aforesaid interconnecting means may also include side engaging means, such as latching tab device. Particularly, receiving contours 58 are arranged to receive a protruding tab from the adjacent intermediate connecting insert member 36, as described below. In a further feature of the invention, the top terminal connecting insert member may also include tube accessory connection means 59, well known to the art.

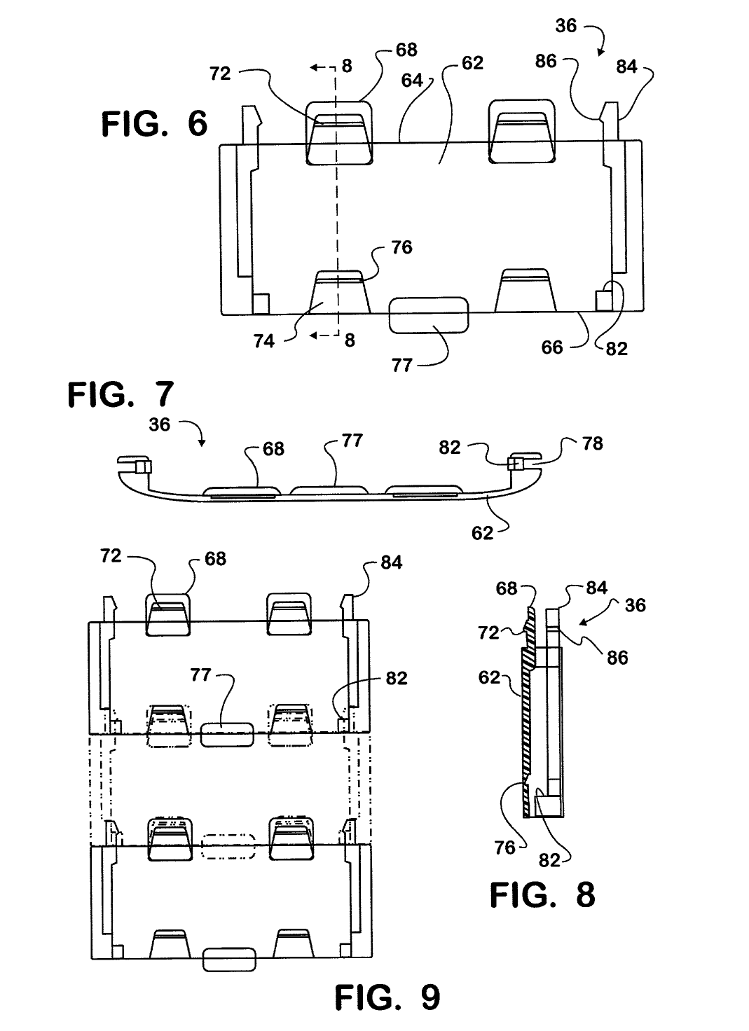

The side connector assembly 24 also includes one or more intermediate connecting insert members 36 (FIGS. 6-9) positioned between the top terminal connecting insert member 32 and the bottom terminal connecting insert member 34. Each intermediate connecting insert member has a substantially planar body portion 62 with opposing side edges for engaging the cage, an upper interconnecting edge 64 and a lower interconnecting edge 66 defined thereon. On these opposing side edges of the intermediate connecting insert member there is provided cage engagement means 78 in the form of cage engagement channels for engaging the cage sides 16. On the upper and lower interconnecting edges are provided insert member interconnecting means for connecting to adjacent insert members. Preferably, this interconnecting means comprises an engaging tab device wherein a projecting tab from one connecting insert member engages a tab engaging contour on an adjacent connecting insert member. Particularly, on the upper edge there are provided protruding tabs 68 with tab latching edges 72 positioned thereon. On the lower edge there are provided latching tab receiving contours 74 with latching edges 76 located therein. Guiding tab 77 is also provided on the lower edge to further secure the connection, in the same manner as aforesaid. (Alternatively, the tab engaging contours may be replaced with engaging tabs and the adjacent engaging insert member may present the tab engaging contours.)

To provide additional engagement between insert members there is also provided side engaging means in the form of latching tab device. Particularly, receiving contours 82 are arranged to receive a protruding tab 84 with a contour engaging edge 86 from an adjacent connecting insert member.

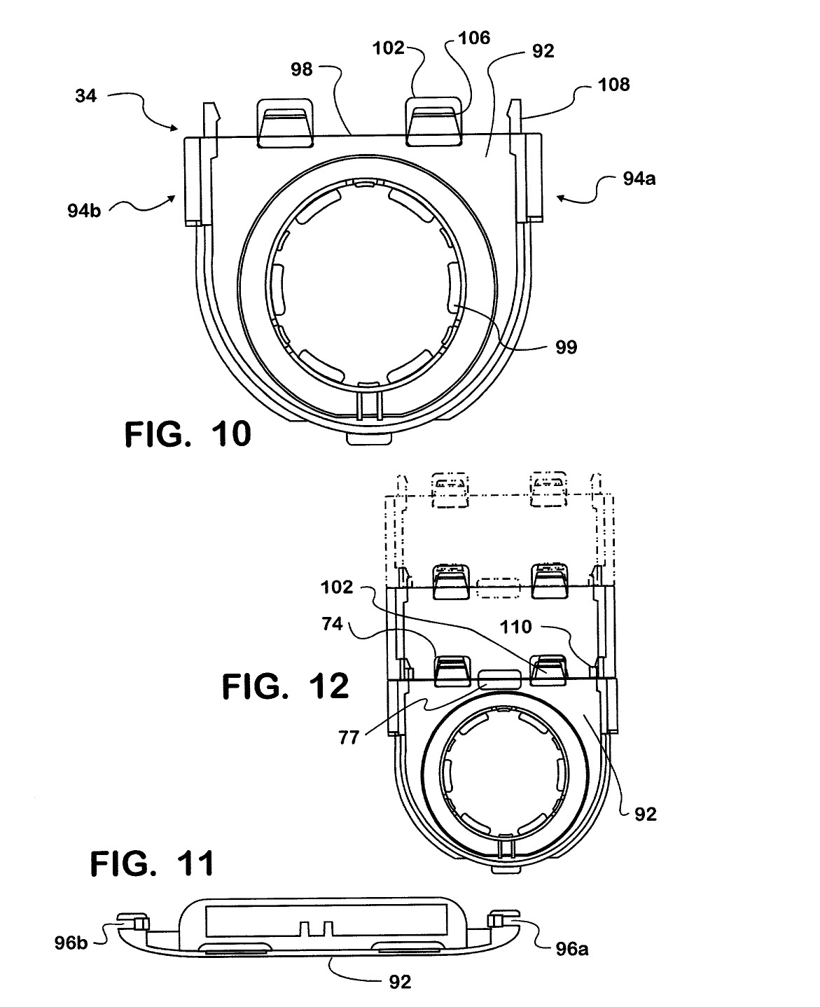

The bottom terminal connecting insert member 34 is depicted in detail in FIGS. 10-12. Particularly, this terminal member has a substantially planar body 92 with opposing side edges 94a and 94b. These opposing side edges present cage engagement means, such as channels 96a and 96b (see FIG. 11), for engaging the cage sides 16. An interconnecting edge 98 is defined on the planar body 92 and presents insert member interconnecting means for connecting to an adjacent insert member. Preferably, this interconnecting means comprises an engaging tab device wherein a projecting tab from one insert member engages a tab engaging contour on an adjacent connecting insert member. Particularly, the insert member interconnecting means includes engaging tabs 102 with a latching edge 106 for engaging an adjacent tab engaging contour 74 within an adjacent insert member, as described above. (Alternatively, engaging tabs may be replaced with engaging contours and the adjacent insert member may present the engaging tabs.)

To provide additional engagement between adjacent connecting insert members there is also provide side engaging means in the form of a latching tab device 108. This latching tab device is the same as previously described with the previous connecting insert members and includes a tab arranged to project into a tab receiving contour in an adjacent insert member. In a further feature of the invention, the bottom terminal connecting insert member may also include tube accessory connection means 99, well known to the art.

From the foregoing description, it will be apparent that modifications can be made to the apparatus and method for using same without departing from the teachings of the present invention. Accordingly, the scope of the invention is only to be limited as necessitated by the accompanying claims.

What is claimed is:

1. A cage connecting insert member for a cage assembly comprising:
a body portion having an interconnecting edge and opposing side edges defined thereon;
cage engagement means located on said opposing side edges for engaging the cage; and
insert member interconnecting means located on said interconnecting edge of the connecting insert member for connecting to an adjacent connecting insert member.

2. The connecting insert member of claim 1 wherein said cage engagement means comprises channels defined along said respective opposing side edges of said connecting insert member.

3. The connecting insert member of claim 1 wherein said insert member interconnecting means comprises an engaging tab device.

4. The connecting insert member of claim 3 further comprising an alignment tab positioned on said interconnecting edge.

5. The connecting insert member of claim 4 further comprising side engaging means for further interconnecting adjacent connecting insert members.

6. The connecting insert member of claim 5 wherein said side engaging means comprises an engaging tab device.

7. The connecting insert member of claim 2 wherein said insert member interconnecting means comprises an engaging tab device.

8. The connecting insert member of claim 7 further comprising an alignment tab positioned on said interconnecting edge.

9. The connecting insert member of claim 8 further comprising side engaging means for further interconnecting adjacent connecting insert members.

10. The connecting insert member of claim 9 wherein said side engaging means comprises an engaging tab device.

11. A terminal connecting insert member for a cage assembly comprising:
a body portion having opposing side edges and an interconnecting edge defined thereon;
cage engagement means located on said opposing side edges for engaging the cage; and
insert member interconnecting means located on said interconnecting edge for connecting to an adjacent connecting insert member.

12. The connecting insert member of claim 11 wherein said cage engagement means comprises a channel defined along said opposing side edges of said connecting insert member.

13. The connecting insert member of claim 11 wherein said insert member interconnecting means comprises an engaging tab device for connecting the terminal connecting insert member to an adjacent connecting insert member.

14. The connecting insert member of claim 13 further comprising an alignment tab for further securing said connecting insert member to an adjacent connecting insert member.

15. The connecting insert member of claim 13 wherein said engaging tab device comprises a projecting tab arranged to engage a tab receiving contour in an adjacent connecting insert member.

16. The connecting insert member of claim 11 further comprising tube connecting means defined in said body portion for connecting to a tube accessory.

17. An assembly of cage connecting insert members for a cage assembly comprising:
top and bottom terminal connecting insert members, wherein each of said terminal connecting insert members comprise
(a) a body portion having opposing side edges and an interconnecting edge defined thereon,
(b) cage engagement means located on said opposing side edges of said terminal connecting insert members for engaging the cage,
(c) insert member interconnecting means located on said interconnecting edge for connecting to an adjacent connecting insert member, and
one or more intermediate connecting insert members, each comprising
(a) a body portion having an upper interconnecting edge, a lower interconnecting edge and opposing side edges defined thereon,
(b) cage engagement means located on said opposing side edges for engaging the cage, and
(c) interconnecting means located on said upper and lower interconnecting edges of said respective intermediate connecting insert members for connecting to adjacent connecting insert members.

18. The connecting insert member of claim 17 wherein said cage engagement means comprises cage engaging channels defined along said opposing side edges of said respective connecting insert members.

19. The connecting insert member of claim 17 wherein said respective insert member interconnecting means comprises engaging tab devices for connecting said connecting insert members to adjacent connecting insert members.

20. The connecting insert member of claim 17 further comprising tube connecting means defined in said respective body portions of said top and bottom terminal connecting insert members for connection to a tube accessory.
